(19) United States
(12) Patent Application Publication
(10) Pub. No.: US 2026/0316151 A1
(43) Pub. Date: Oct. 15, 2026

(54) TEMPERATURE CONTROL OF CASTER WHEEL ASSEMBLY OF BATTERY COMPONENT CONTINUOUS CASTING MACHINE

(71) Applicant: Wirtz Manufacturing Company, Inc., Port Huron, MI (US)

(72) Inventors: Michael R. Romeo, St. Clair, MI (US); Jason P. Miller, St. Clair, MI (US)

(21) Appl. No.: 19/643,981

(22) Filed: Apr. 10, 2026

Related U.S. Application Data
(60) Provisional application No. 63/786,369, filed on Apr. 10, 2025.

(51) Int. Cl. B22D 11/06; H01M 4/04; H01M 10/12

(52) U.S. Cl. CPC B22D 11/0602; B22D 11/0682; H01M 4/0485; H01M 10/12

(57) ABSTRACT

A belt caster wheel assembly for a battery component continuous casting machine is set forth. As main components, the belt caster wheel assembly has a rotatable caster wheel, a moveable belt, and one or more temperature-controlled shoes. Compared to past approaches, the belt caster wheel assembly exhibits a heightened degree of temperature control capabilities at and/or near a mold cavity of the rotatable caster wheel, enabling a faster run-rate thereof and an increased production effectiveness and efficiency of a continuous strip of battery components that are ultimately produced. In various implementations, the temperature control capabilities are effected via one or more of: pockets residing at the mold cavity, one or more internal recesses residing in a cylindrical wall of the rotatable caster wheel, and/or one or more inserts disposed at an interior region of the cylindrical wall.

### CROSS-REFERENCE TO RELATED APPLICATION

This patent application claims the benefit of U.S. Provisional Patent Application No. 63/786,369, with a filing date of Apr. 10, 2025, the contents of which are hereby incorporated by reference in their entirety.

### TECHNICAL FIELD

This disclosure relates generally to equipment for battery component manufacture and, more particularly, to a machine for continuously casting battery components such as battery foils and battery grids.

### BACKGROUND

Batteries are a common source of electrical energy and are often used as automotive batteries, aeronautic batteries, marine batteries, consumer equipment batteries, small engine batteries, industrial batteries, as well as other mobile and stationary applications. Different types of batteries have different components.

Certain types of lead-acid batteries, for example, include numerous positive and negative plates made of lead-based alloy metal grids with an electrochemically-active battery paste material applied thereon. The grids serve as the current conductor or collector of the established electrode, and the paste material serves as the active electrochemical material of the electrode. Making lead-based grids, and particularly those of the positive kind, remains an important part in the manufacture of commercially suitable lead-acid batteries. It often involves considerable metallurgic microstructure control to impart satisfactory mechanical strength, corrosion resistance, creep resistance, paste adhesion, as well as other sought-after properties.

Batteries with bipolar architectures, on the other hand, are chemistry agnostic but most are of the lead-acid type. Bipolar batteries typically have individual electrochemical cell compartments that are isolated by current collectors. Each current collector—also called a bipole—has positive electrochemically active material at one side and has negative electrochemically active material at an opposite side. Bipoles can take the form of a thin foil composed of a lead-based alloy metal. Still, efficient commercial production of thin foil bipoles remains an industry challenge.

### SUMMARY

In an embodiment, a belt caster wheel assembly for a battery component continuous casting machine may include a rotatable caster wheel, a moveable belt, and one or more temperature-controlled shoes. The rotatable caster wheel has a cylindrical wall with a mold cavity residing at an exterior surface of the cylindrical wall. The mold cavity has a multitude of first grooves, a multitude of second grooves, and a multitude of lands. The first grooves and second grooves intersect one another. The lands are established among the first grooves and the second grooves and the intersections. The mold cavity also has a multitude of pockets. The pockets reside in some or more of the lands. The moveable belt is in confrontation with a circumferential working region of the mold cavity. The circumferential working region is constituted by some or more of the first grooves, second grooves, lands, and pockets. The temperature-controlled shoe(s) is in engagement with the moveable belt at least near the confrontation of the moveable belt with the circumferential working region.

In an embodiment, a belt caster wheel assembly for a battery component continuous casting machine may include a rotatable caster wheel, a moveable belt, and one or more temperature-controlled shoes. The rotatable caster wheel has a cylindrical wall with a mold cavity residing at an exterior surface of the cylindrical wall. The cylindrical wall has one or more internal recesses residing therein. The internal recess(es) underlies a section or more of the mold cavity. The moveable belt is in confrontation with a circumferential working region of the mold cavity. The temperature-controlled shoe(s) is in engagement with the moveable belt at least near the confrontation of the moveable belt with the circumferential working region.

In an embodiment, a belt caster wheel assembly for a battery component continuous casting machine may include a rotatable caster wheel, one or more inserts, a moveable belt, and one or more temperature-controlled shoes. The rotatable caster wheel has a cylindrical wall with a mold cavity residing at an exterior surface of the cylindrical wall. The mold cavity has a multitude of first grooves, a multitude of second grooves, and a multitude of lands. The lands are established among the first grooves and the second grooves. The mold cavity also has a multitude of pockets. The pockets reside in some or more of the lands. The cylindrical wall has one or more internal recesses residing therein. The internal recess(es) underly a section or more of the mold cavity. The insert(s) is disposed within the internal recess(es). The moveable belt is in confrontation with a circumferential working region of the mold cavity. The circumferential working region is constituted by some or more of the first grooves, second grooves, lands, and pockets. The temperature-controlled shoe(s) is in engagement with the moveable belt at least near the confrontation of the moveable belt with the circumferential working region.

Further scope of applicability of the present disclosure will become apparent from the detailed description provided hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 is a perspective view of an embodiment of a battery component continuous casting machine equipped with an embodiment of a belt caster wheel assembly;

FIG. 2 is a perspective view of the battery caster wheel assembly;

FIG. 3 is a schematic view of the belt caster wheel assembly;

FIG. 4 shows an embodiment of a continuous strip of a multitude of serially-connected lead-acid battery metal grids;

FIG. 5 is a sectional view of a first embodiment of a rotatable caster wheel having an embodiment of pockets residing therein;

FIG. 6 is an enlarged view of the pockets of the first embodiment of the rotatable caster wheel taken at circle 6 in FIG. 5;

FIG. 7 is an enlarged sectional view of the pockets of the first embodiment of the rotatable caster wheel;

FIG. 8 is a sectional view of a second embodiment of the rotatable caster wheel having an embodiment of internal recesses residing therein;

FIG. 9 is an enlarged view of the internal recesses of the second embodiment of the rotatable caster wheel taken at circle 9 in FIG. 8;

FIG. 10 is a segmented sectional view of the internal recesses of the second embodiment of the rotatable caster wheel;

FIG. 11 is an enlarged sectional view of the internal recesses of the second embodiment of the rotatable caster wheel;

FIG. 12 is a bottom view of the second embodiment of the rotatable caster wheel, showing the internal recesses thereof;

FIG. 13 is a segmented sectional view of a third embodiment of the rotatable caster wheel having an embodiment of an insert disposed therein;

FIG. 14 is a bottom view of a fourth embodiment of the rotatable caster wheel having another embodiment internal recesses residing therein;

FIG. 15 is an enlarged view of the internal recesses of FIG. 14 taken at oval 15 in FIG. 14;

FIG. 16 is a sectional view of a fifth embodiment of the rotatable caster wheel having yet another embodiment of internal recesses residing therein;

FIG. 17 is a segmented sectional view of the fifth embodiment of the rotatable caster wheel;

FIG. 18 is a segmented sectional view of a sixth embodiment of the rotatable caster wheel having another embodiment of an insert disposed therein; and

FIG. 19 is a side view of a seventh embodiment of the rotatable caster wheel having a further embodiment of internal recesses residing therein.

### DETAILED DESCRIPTION

With reference to the figures, embodiments of a battery component continuous casting machine 10 (hereafter, continuous casting machine) equipped with a belt caster wheel assembly 12 are shown and described herein. Battery components made by the continuous casting machine 10 and belt caster wheel assembly 12 can include lead-based metal grids for lead-acid batteries, as well as lead-based metal foils for bipolar batteries, among other possible components. The battery components, when made, are serially-connected in a continuous strip as they exit the continuous casting machine 10. Compared to past approaches, the belt caster wheel assembly 12 is designed and constructed with a heightened degree of temperature control capabilities at and/or near a mold cavity of the belt caster wheel assembly 12, enabling a faster run-rate thereof and an increased production effectiveness and efficiency of the continuous strip of battery components. A greater utilization efficiency of temperature-controlled shoes is furnished in the continuous casting machine 10 and belt caster wheel assembly 12, and a greater use and precision of heating and/or cooling effects via the temperature-controlled shoes is provided. An undesirable expenditure of the heating and/or cooling effects within non-working portions of a mold cavity wall—observed in certain past approaches—is minimized. Thermal reactivity at the mold cavity is enhanced. Therefore, desired and sought-after properties and metallurgic microstructure control of the produced battery components is more readily attained, such as imparted mechanical strength and structural integrity, corrosion resistance, creep resistance, and paste adhesion. Overall, a more effective and efficient continuous casting machine and process and procedure for battery component production is furnished, enhancing facilitation of commercial and mass production operations.

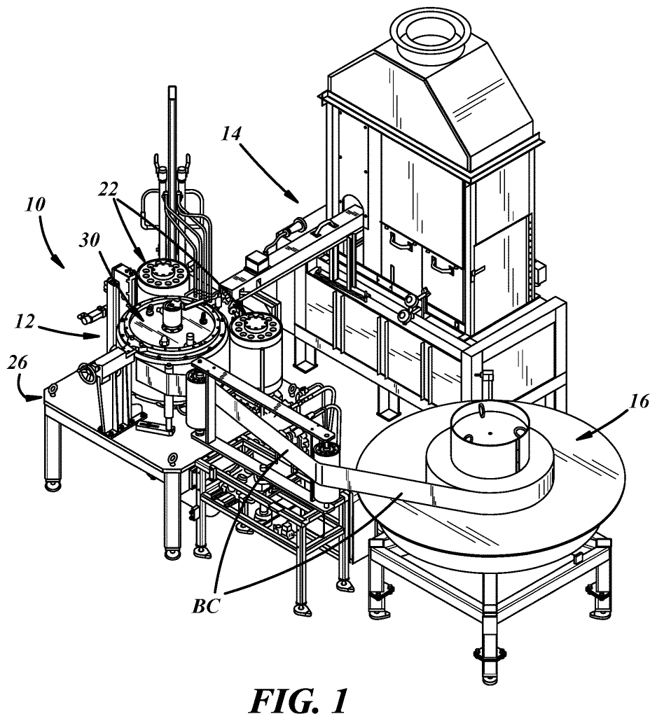

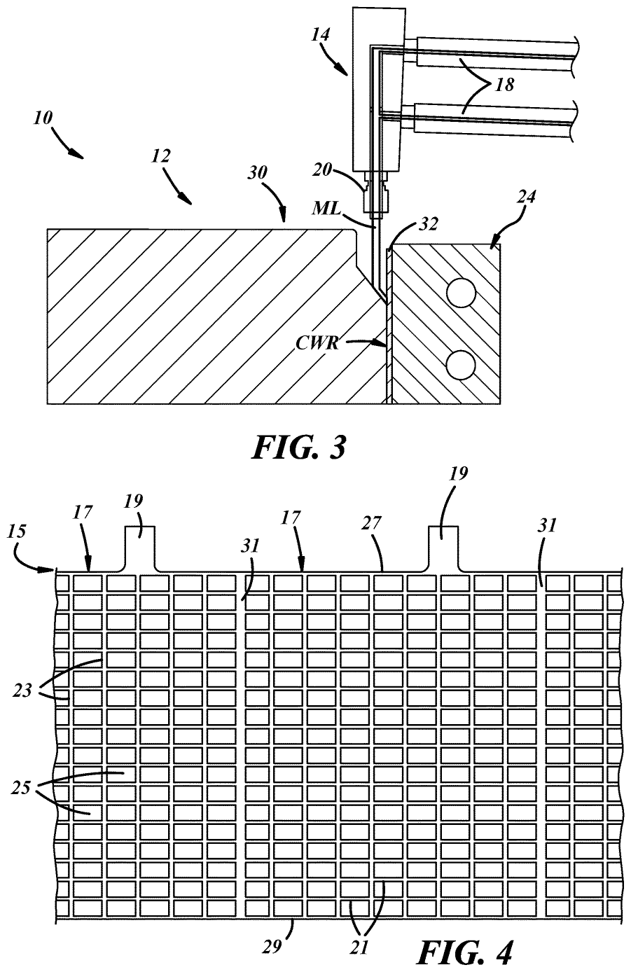

The continuous casting machine 10 can be employed in operation to continuously cast a continuous strip of a multitude of serially-connected lead-acid battery metal grids or a continuous strip of a multitude of axial serially-connected bipolar battery metal foils. With reference to FIG. 1, the continuous casting machine 10 can be part of a larger casting system and line that may further include a liquid and molten lead or lead alloy supply and delivery system 14 (hereafter, molten lead delivery system) equipped upstream of the continuous casting machine 10, and a coiling machine 16 equipped downstream of the continuous casting machine 10 (unless otherwise specified in a particular circumstance of usage, the terms upstream and downstream are used in this description with reference to the general direction of forward manufacturing progression of the battery components). With reference now to FIG. 3, the molten lead delivery system 14 serves to deliver molten lead or lead alloy ML to a mold cavity (introduced below) of the belt caster wheel assembly 12 via feed lines 18 and a feed head 20 during operation of the continuous casting machine 10. The coiling machine 16, on the other hand, serves to spool the continuous strip of battery components BC (FIG. 1) produced by the caster wheel assembly 12, whether the battery components BC are lead-based metal grids for lead-acid batteries or lead-based metal foils for bipolar batteries.

In general, the continuous casting machine 10 has been shown to produce battery components of metal composition exhibiting a desirably relatively small grain size, relatively uniform grain size, and a crystal morphology throughout the metal structure. It has been determined that these enhanced grain properties are due in part or more to the machine's gravity-fed liquid lead or lead alloy delivery capabilities. The continuous casting machine 10 can have various designs, constructions, and components in various embodiments. In the embodiment of the figures, the continuous casting machine 10 includes—as some of its primary components and assemblies—the belt caster wheel assembly 12, a pair of rollers 22, a pair of temperature-controlled shoes 24, and a frame 26. Still, in other embodiments, the continuous casting machine could have more, less, and/or different primary components and assemblies. Examples of such continuous casting machines are set forth in U.S. Pat. No. 12,138,681, assigned to the present applicant, the contents of which are hereby incorporated by reference herein in their entirety.

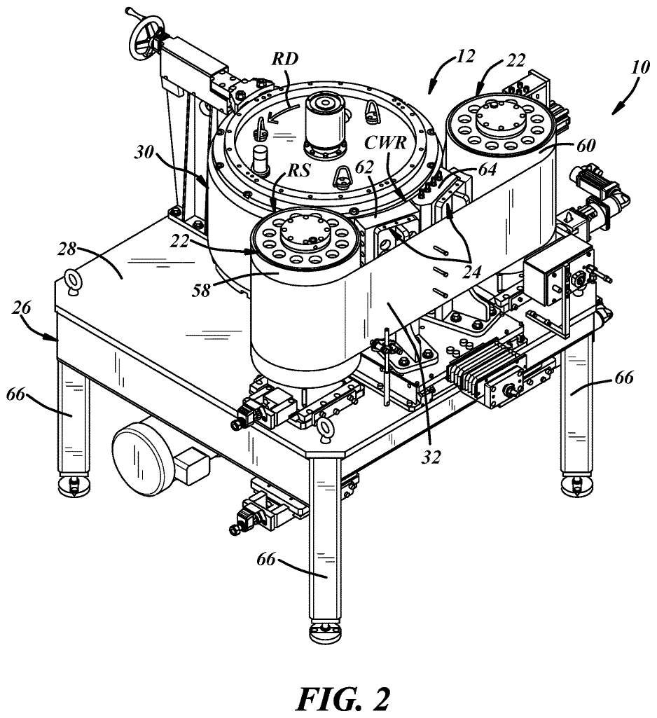

The belt caster wheel assembly 12 serves to continuously cast the continuous strip of the multitude of serially-connected lead-acid battery metal grids or the continuous strip of the multitude of serially-connected bipolar battery metal foils during operation of the continuous casting machine 10. The belt caster wheel assembly 12 is driven to rotate rapidly during operation by a drive motor (unshown) supported beneath a top wall 28 (FIG. 2) of the frame 26. The drive motor can be of the variable speed electric motor type, or another type, and can have its activation and deactivation and other parameters managed by a system controller such as a programmable logic controller (PLC). A gearbox can be equipped with the drive motor. The belt caster wheel assembly 12 is situated and supported atop the top wall 28 of the frame 26 adjacent the rollers 22 and shoes 24. The belt caster wheel assembly 12 can have various designs, constructions, and components in various embodiments. In this embodiment, and with general reference to FIGS. 2, 3, and 5, the belt caster wheel assembly 12 includes a rotatable caster wheel 30 and a moveable belt 32; still, in other embodiments the belt caster wheel assembly 12 could include more, less, and/or different components.

The rotatable caster wheel 30 is directly driven to rotate during operation by the drive motor. In this embodiment, the rotatable caster wheel 30 is made-up of a cylindrical wall 34, a top wall 36, and a bottom wall 38. The top wall 36 and bottom wall 38 are affixed to the cylindrical wall 34 such as via bolting, and close the top and bottom ends of the cylindrical wall 34. Together, the cylindrical wall 34, top wall 36, and bottom wall 38 make a hollow cylindrically-shaped structure. An interior 40 resides at an inside of the hollow cylindrically-shaped structure and is defined by interior confronting surfaces of the cylindrical, top, and bottom walls 34, 36, 38. At an exterior surface 42 of the cylindrical wall 34, a mold cavity 44 resides wholly around a circumference thereof. The mold cavity 44 can itself constitute a region or more of the exterior surface 42 of the cylindrical wall 34. The mold cavity 44 serves to provide a negative space for accepting delivery of the molten lead or lead alloy ML via the molten lead delivery system 14 during operation of the continuous casting machine 10, and for ultimate formation of the continuous strip of battery components BC. The mold cavity 44 can be a single, uninterrupted mold cavity spanning wholly around the circumference of the cylindrical wall 34, and can be made-up of multiple individual grid or foil mold cavities situated one-after-another therearound. Because the mold cavity 44 receives delivery of the molten lead or lead alloy ML, the rotatable caster wheel 30 itself can experience increased heat conduction and increased temperatures. To manage thermal conduction and transfer at the rotatable caster wheel 30, the rotatable caster wheel 30 can be outfitted with a liquid-cooled assembly or an air-cooled assembly. In the liquid-cooled assembly, internal coolant passages can reside within the cylindrical wall 34 for recirculation of coolant fluid-flow such as water fluid-flow. In the air-cooled assembly, on the other hand, air can be circulated within the interior 40 of the rotatable caster wheel 30. Still, in the embodiments presented herein employed with the temperature control and management capabilities, such liquid-cooled assemblies and air-cooled assemblies can be obviated and not a part of the design and construction of the rotatable caster wheel 30—this constitutes one of the advancements facilitated via the temperature control and management capabilities herein.

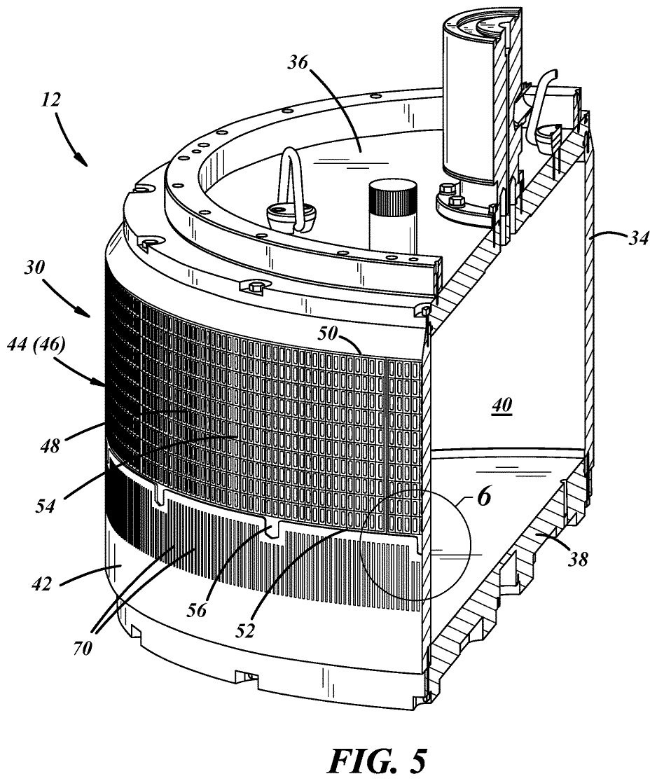

Depending on its intended production, the mold cavity 44 can be a grid mold cavity 46 or a foil mold cavity (unshown). Once solidified and upon exiting the belt caster wheel assembly 12, the grid mold cavity 46 forms the continuous strip of metal grids, and the foil mold cavity forms the continuous strip of metal foils. Initially, the strip of metal strips and foils are connected together, but are ultimately severed and separated downstream the continuous casting machine 10 into individual battery metal grids and individual battery metal foils. The battery metal grids and foils are typically planar and thin, and designed and constructed per parameters of the battery in which they will be installed. The grid mold cavity 46 is depicted best in FIG. 5. Sections of the grid mold cavity 46 are engraved within cylindrical wall 34. The grid mold cavity 46, per this example embodiment, has a central grid wire section 48 with many horizontally-extending grid wires and many vertically-extending grid wires configured in a crisscrossing and intersecting arrangement. Bottom and top frame sections 50, 52 bound upper and lower extents of the central grid wire section 48, and side frame sections 54 bound side extents thereof. Further, each individual battery metal grid produced has a connector lug, and hence the grid mold cavity 46 has an associated lug section 56 for formation thereof. The molten lead or lead alloy ML flows to all of the central grid wire section 48, bottom and bottom and top sections 50, 52, side frame sections 54, and lug sections 56 for proper formation of the produced battery metal grids during operation of the continuous casting machine 10.

With reference now to FIG. 4, an example of an as-cast continuous strip of the multitude of serially-connected lead-acid battery metal grids 15 or elongated web is depicted. The battery metal grids 15 can be formed by use of the belt caster wheel assembly 12 and via the grid mold cavity 46. The battery metal grids 15 include multiple individual battery metal grids 17 that are connected together at this stage of processing, but are ultimately severed and separated prior to installation in a lead-acid battery. The grids 17 are typically flat, planar, and thin, and designed and constructed per parameters of the lead-acid battery in which they are installed. The grids 17 can be utilized for a positive plate (i.e., cathode) and a negative plate (i.e., anode) of an assembled lead-acid battery. In the example of FIG. 4, the battery metal grids 15 include connector lugs 19 provided for each grid 17. The battery metal grids 15 and each individual grid 17, per this example, have a multitude of horizontally-extending grid wires 21 and a multitude of vertically-extending grid wires 23 in a crisscrossing and orthogonal arrangement. The grid wires 21, 23 intersect one another at nodes, and open and empty spaces 25 reside among the grid wires 21, 23. A top frame wire 27 and a bottom frame wire 29 bound the associated extents of the battery metal grids 15 and each individual grid 17, and side frame wires 31 bound sides of each grid 17.

Still, the produced battery metal grids could have other designs, constructions, and arrangements in other examples; for instance, two sets of continuous strips connected in parallel could be cast concurrently, and/or the grid wires could have other arrangements such as an angular zig-zag pattern. Such alternatives will be appreciated by skilled artisans. Furthermore, a gate or runner system located adjacent a top end of the cylindrical wall 34 can be provided. When provided, the runner system fluidly communicates with the mold cavity 44 and serves to facilitate and ease the supply and delivery of the molten lead or lead alloy ML to the mold cavity 44. The runner system can include a series of elongated and axially-directed ribs with channels residing between neighboring ribs (unless otherwise specified in a particular circumstance of usage, the terms axial, radial, and circumferential—as well as their grammatical variations—are used in this description with reference to the generally cylindrical shape of the rotatable caster wheel). The channels can serve as flues for the flow of the molten lead or lead alloy ML.

With reference now to FIGS. 2 and 3, the moveable belt 32 moves in coordination with the rotatable caster wheel 30 and comes into confrontation with a moving circumferential working region CWR of the rotatable caster wheel 30 in order to continuously cast the continuous strip of the multitude of serially-connected lead-acid battery metal grids or the continuous strip of the multitude of serially-connected bipolar battery metal foils during operation of the continuous casting machine 10. The moveable belt 32 overlies the mold cavity 44 and can overlie the runner system (when provided), and is urged against the rotatable caster wheel 30 via the temperature-controlled shoes 24 in sealing engagement at the circumferential working region CWR where the molten lead or lead alloy ML is delivered to the mold cavity 44 and sufficiently downstream thereof for the molten lead or lead alloy ML to substantially solidify before the continuous strip of battery components BC exit the mold cavity 44. Movement of the rotatable caster wheel 30 drives movement of the moveable belt 32. In construction, the moveable belt 32 can possess a vertical and transverse width that is greater than the vertical and axial extent of the mold cavity 44 and the runner system. Further, the moveable belt 32 can be composed of a stainless-steel material, can be endless, and can be relatively thin and flexible in nature. In embodiments in which the moveable belt 32 moves at the same tangential speed as the rotatable caster wheel 30, there may be no relative movement between the moveable belt 32 and rotatable caster wheel 30; here, it has been found that friction is minimized or substantially lacking therebetween, and hence a lead antimony alloy with an antimony content of approximately three percent (3%) by weight, for example—previously unavailable—can be utilized as the material of the continuous strip of battery components BC. Still, in other embodiments, slight relative movement may exist between the moveable belt 32 and rotatable caster wheel 30 amid operation of the continuous casting machine 10.

With reference to FIG. 2, the rollers 22 serve to support continuous movement of the moveable belt 32 amid operation of the continuous casting machine 10, and are mounted on the top wall 28 of the frame 26. In this embodiment there are a total of two rollers—a first roller and a second roller 60; still, in other embodiments there could be other quantities of rollers such as four rollers or more or less. The first roller 58 is situated at an upstream side of the temperature-controlled shoes 24 with respect to a rotational direction RD of the rotatable caster wheel 30 during use of the continuous casting machine 10. The second roller 60, on the other hand, is situated at a downstream side of the temperature-controlled shoes 24 with respect to the rotational direction RD. The first and second rollers 58, 60 are journaled for rotation at their respective locations via associated shafts. Rotational movement of the first and second rollers 58, 60 is driven by the moveable belt 32.

With reference to FIGS. 2 and 3, the temperature-controlled shoes 24 serve to urge the moveable belt 32 into firm sealing engagement with the rotatable caster wheel 30 and, depending on their arrangement and type, can serve to promote full filling with the molten lead or lead alloy ML of the complete vertical extent of the circumferential working region CWR of the mold cavity 44 and/or can serve to promote rapid solidification of the molten lead or lead alloy ML in the mold cavity 44. There can be various quantities and arrangements of the shoes in various embodiments, and the shoes themselves can have various designs, constructions, and components in various embodiments. In the embodiment of FIGS. 2 and 3, a total of two shoes are provided—a heating shoe 62 and a cooling shoe; still, in other embodiments there could be other quantities of shoes such as four shoes or more or less.

The heating shoe 62 can exhibit an arcuate front face for complementary confrontation with the rotatable caster wheel 30, and the cooling shoe 64 can likewise exhibit an arcuate front face for the same purpose. The heating and cooling shoes 62, 64 are situated immediately next to each other, with the heating shoe 62 positioned upstream relative to the cooling shoe 64 with respect to the rotational direction RD of the rotatable caster wheel 30, and hence the cooling shoe 64 positioned downstream relative to the heating shoe 62. The heating shoe 62 is situated at the site of molten lead or lead alloy supply and delivery between the rotatable caster wheel 30 and moveable belt 32 in order to aid complete filling with the molten lead or lead alloy ML of the circumferential working region CWR of the mold cavity 44 prior to solidification occurring. The molten lead or lead alloy ML can more readily make its way to a lower and bottom region of the mold cavity 44 with use of the heating shoe 62. The heating shoe 62 can be equipped with internal electric heating elements to generate increased heat within the heating shoe 62. The generated heat is, in turn, furnished from the heating shoe 62 and to the moveable belt 32 and to the circumferential working region CWR of the mold cavity 44 via the engagements thereamong. Conversely, to actively decrease the temperature of, and hence cool, the cooling shoe 64, liquid coolant supply and return lines can communicate with interior passages of the cooling shoe 64 for circulation therethrough.

The Frame 26 Serves to Carry and Support Primary Components and Assemblies of the continuous casting machine 10. The frame 26 can have various designs, constructions, and components in various embodiments, some of which may be dictated in part or more by the design and construction and components of the caster wheel assembly 12. With reference to FIG. 2, in this embodiment the frame 26 includes the top wall 28 and four structural legs 66. The rotatable caster wheel 30, moveable belt 32, first and second rollers 58, 60, and heating and cooling shoes 62, 64 are all supported and carried at the top wall 28, among other components and assemblies possibly situated thereon.

Rotational speed and operational run-rate of the rotatable caster wheel 30—while producing quality battery components—has been determined to be dictated in large part by heating and/or cooling effectiveness and efficiency delivered via the temperature-controlled shoes 24 (i.e., in the embodiment presented above, the heating and/or cooling shoes 62, 64). The greater effectiveness and efficiency, the higher rotational speed and operational run-rate; and conversely, the lesser effectiveness and efficiency, the lower rotational speed and operational run-rate. In certain past approaches, it has been observed that heating and/or cooling effects can be dissipated via non-working portions of the cylindrical wall 34 of the rotatable caster wheel 30, rather than being more effectively and efficiently utilized at the circumferential working region CWR of the mold cavity 44. Non-working portions of the cylindrical wall 34 have been found to include internal portions of the cylindrical wall 34 distanced radially-inwardly from the exterior surface 42 of the cylindrical wall 34, among other possible locations. Needlessly expending heating and/or cooling effects serves to restrain the effective rotational speed and operational run-rate of the rotatable caster wheel 30.

To resolve the shortcomings observed in certain past approaches, an increased degree of temperature control and management capabilities is introduced at and/or near the exterior surface 42 and mold cavity 44 of the cylindrical wall 34. The heating and/or cooling effects furnished via the temperature-controlled shoes 24 are more readily concentrated at the circumferential working region CWR of the mold cavity 44, and at the intended working sections of the mold cavity 44 that—in case of the grid mold cavity 46—can include one or more or all of the central grid wire section 48, grid wire sections, bottom and top frame sections 50, 52, side frame sections 54, and/or lug sections 56. Dissipation of the heating and/or cooling effects at non-working portions of the cylindrical wall 34 is thereby reduced. The working sections of the mold cavity 44 have proven to exhibit an enhanced thermal reactivity when subjected to the heating and/or cooling effects furnished externally via the temperature-controlled shoes 24 with employment of the temperature control and management capabilities of the embodiments presented below. A faster rotational speed and operational run-rate of the rotatable caster wheel 30, while still producing quality battery components, is enabled. Indeed, in one or more of the embodiments set forth herein, the rotational speed and operational run-rate of the rotatable caster wheel 30 can be improved by approximately thirty percent (30%); still, other improvements that are more or less are possible. The temperature control and management capabilities can exhibit various designs, constructions, and components in various embodiments.

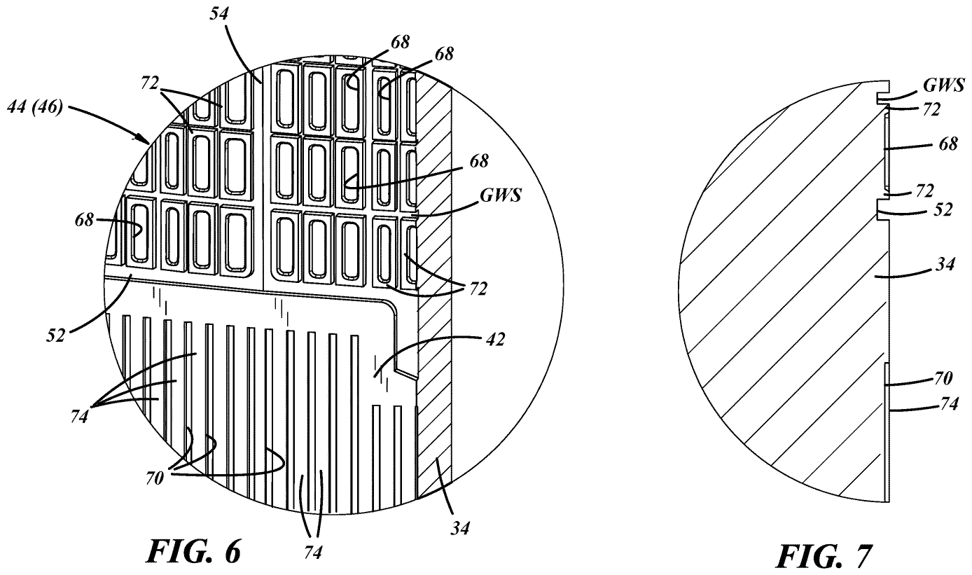

With reference now to FIGS. 5-7, a first embodiment of the rotatable caster wheel 30 exhibits the temperature control and management capabilities via a multitude of pockets 68 and via a multitude of depressions 70. The pockets 68 and depressions 70 can have various designs and constructions in various embodiments. In general, the pockets 68 and depressions 70 are voids that serve to substantially preclude the transfer of heating and/or cooling effects from the temperature-controlled shoes 24 and/or from the moveable belt 32 in areas in which such transfer of heating and/or cooling is less desirable. The pockets 68 are generally located at the mold cavity 44 and, because they are voids, decrease the surface area of the mold cavity 44 that makes direct surface-to-surface contact and comes into direct surface-to-surface abutment with the moveable belt 32 at the circumferential working region CWR during use of the continuous casting machine 10 and belt caster wheel assembly 12. Without the direct surface-to-surface contact and abutment, the unwanted transfer of heating and/or cooling effects is more readily prevented. In the first embodiment, and in the case of the grid mold cavity 46, the pockets 68 are situated within lands 72. The lands 72 are established among the crisscrossing and intersecting arrangement of the grid wire sections (denoted GWS in FIGS. 6 and 7) and bottom and top frame sections 50, 52 and side frame sections 54. In this embodiment, the pockets 68 reside in all of the lands 72; but in other embodiments the pockets 68 could reside in less than all of the lands 72.

Further, each of the pockets 68 has a generally rectangular shape that resembles the shape of the respective land 72 in which the pocket 68 occupies, and each of the pockets 68 is centrally situated within the respective land 72. Each of the pockets 68 has a first area of expanse defined by the void it creates which is greater than a second area of expanse defined by respective land 72. In other words, the pockets 68 remove more surface area of contact and abutment with the moveable belt 32 than that which remains with the lands 72. Overall, the area of voids created by the pockets 68 is greater in value than the remaining area of the lands 72, per the first embodiment. Maintaining this relationship has been shown to furnish suitable temperature control and management capabilities at the mold cavity 44, and more readily concentrates the heating and/or cooling effects at the intended working sections of the mold cavity 44 (e.g., in the case of the grid mold cavity 46, the intended working sections can include one or more or all of the grid wire sections GWS, bottom and top frame sections 50, 52, side frame sections 54, and/or lug sections 56), according to this embodiment; still, this relationship need not necessarily be true in other embodiments. As best shown in the enlarged view of FIG. 6, the lands 72 are constituted by rectangularly-shaped protrusions with hollowed-out center sections established by the pockets 68. The heating and/or cooling effects from the temperature-controlled shoes 24 and/or from the moveable belt 32 are transferred via these rectangularly-shaped protrusions of the lands 72 rather than the voids of pockets 68. The lands 72 make direct surface-to-surface contact and come into direct surface-to-surface abutment with the moveable belt 32 at the circumferential working region CWR during use of the continuous casting machine 10 and belt caster wheel assembly 12. Yet further, and as shown best in the side sectional view of FIG. 7, a first radial depth of the pockets 68 is lesser in value than a second radial depth of the grid wire sections GWS and of the bottom and top frame sections 50, 52. The first radial depth of the pockets 68, per an example, can have a value of approximately thirty thousandths of an inch (0.03 inches; 0.762 millimeters); still, other radial depth values are possible in other examples. The pockets 68 can be formed via machining or via another formation technique.

With general reference again to FIGS. 5-7, the depressions 70 are generally located at the exterior surface 42 of the cylindrical wall 34 and axially beneath the mold cavity 44 and adjacent a lower region of the cylindrical wall 34. In this embodiment, the depressions 70 are located at a non-working portion of the cylindrical wall 34. The depressions 70 are constituted by axially-and vertically-arranged slotted voids residing in the cylindrical wall 34 and spanning wholly around the circumference of the cylindrical wall 34. The depressions 70 are elongated in the axial direction. An axial extent of the depressions 70 downward from the mold cavity 44 is sufficient to fully underlie an overlying lower section of the temperature-controlled shoes 24 and/or the moveable belt 32 during use of the continuous casting machine 10 and belt caster wheel assembly 12. Because they are voids, the depressions 70 decrease the surface area that makes direct surface-to-surface contact and comes into direct surface-to-surface abutment with the moveable belt 32 and/or with the temperature-controlled shoes 24 during use. Without the direct surface-to-surface contact and abutment, the unwanted transfer of heating and/or cooling effects at the location of the depressions 70 is more readily prevented. As with the pockets 68, a radial depth of the depressions 70 is lesser in value than the second radial depth of the grid wire sections GWS and of the bottom and top frame sections 50, 52. The radial depth of the depressions 70, per an example, can have a value of approximately thirty thousandths of an inch (0.03 inches; 0.762 millimeters); still, other radial depth values are possible in other examples. The depressions 70 can be formed via machining or via another formation technique.

Further, with particular reference to FIG. 6, a multitude of land strips 74 are established by way of the depressions 70. Like the depressions 70, the land strips 74 are generally located at the exterior surface 42 of the cylindrical wall 34 and axially beneath the mold cavity 44 and adjacent the lower region of the cylindrical wall 34. In this embodiment, the land strips 74 are located at the same non-working portion of the cylindrical wall 34 as the depressions 70. The land strips 74 are constituted by axially-and vertically-arranged portions of the cylindrical wall 34 that remain post-formation of the depressions 70. The land strips 74 span wholly around the circumference of the cylindrical wall 34. Furthermore, the land strips 74 are elongated in the axial direction. The land strips 74 do not protrude radially-outboard of the exterior surface 42 and of the lands 72 according to this embodiment, as perhaps demonstrated best by FIG. 7; rather, the land strips 74 are generally flush in the axial direction with the exterior surface 42 and with the lands 72. An axial extent of the land strips 74 downward from the mold cavity 44 is sufficient to fully underlie an overlying lower section of the temperature-controlled shoes 24 and/or the moveable belt 32 during use. The temperature-controlled shoes 24 and/or the moveable belt 32 engages and makes direct surface-to-surface contact and comes into direct surface-to-surface abutment with the land strips 74 during use of the continuous casting machine 10 and belt caster wheel assembly 12. Since the engaged surface area from the temperature-controlled shoes 24 and/or the moveable belt 32 is decreased via the depressions 70 and land strips 74, a reduced amount of heating and/or cooling effects is drawn therefrom at this location.

Still further, in alternative embodiments, the pockets and depressions and land strips need not necessarily be provided together in a rotatable caster wheel; for example, the pockets could be provided in a rotatable caster wheel in the absence of the depressions and land strips, and conversely, the depressions and land strips could be provided in a rotatable caster wheel in the absence of the pockets.

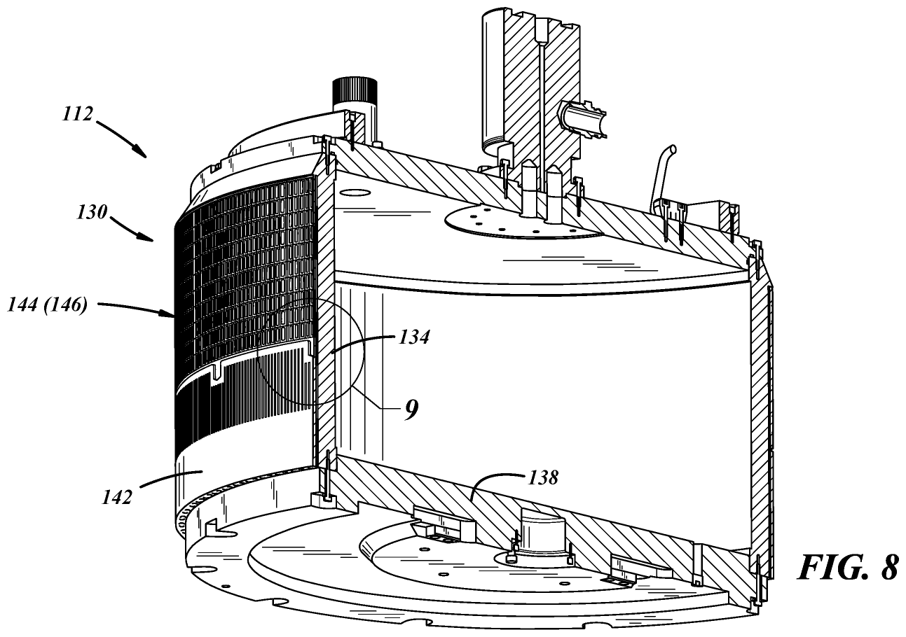

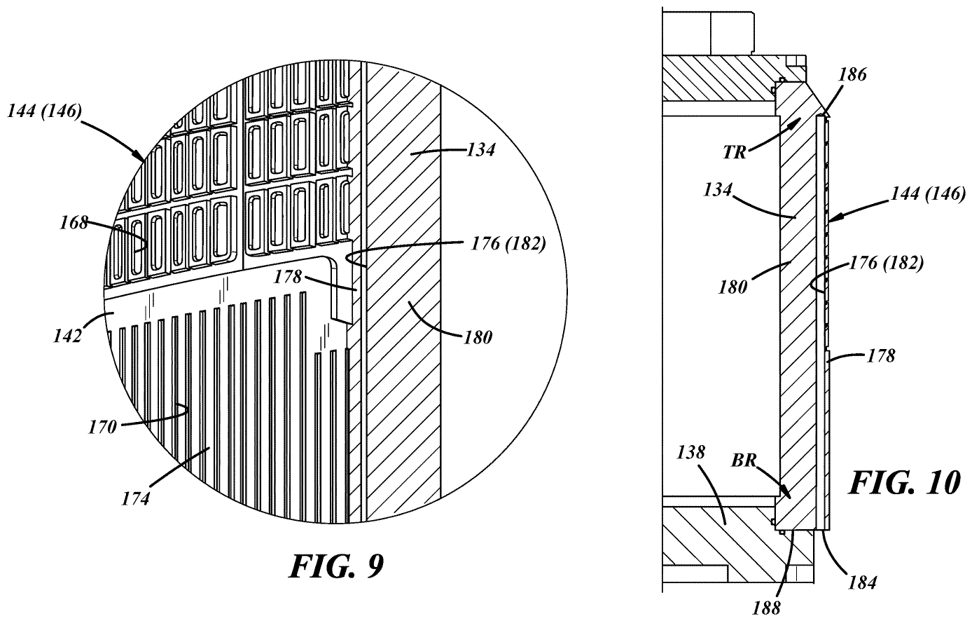

Turning now to FIGS. 8-12, a second embodiment of the rotatable caster wheel is presented. In the second embodiment, certain corresponding components and elements are numbered similarly but with numerals 1xx when referring to this second embodiment. For example, the rotatable caster wheel is referenced by numeral 30 in the first embodiment and is correspondingly referenced by numeral 130 in the second embodiment. Moreover, many similarities exist between the first embodiment and the second embodiment, some of which may not be repeated here in the description of the second embodiment. At least certain appreciable differences between the embodiments are described.

In the second embodiment, the rotatable caster wheel 130 exhibits the temperature control and management capabilities via a multitude of internal recesses 176. The internal recesses 176 can have various designs and constructions in various embodiments. In general, the internal recesses 176 are internal voids that serve to substantially preclude the transfer of heating and/or cooling effects from the temperature-controlled shoes 24 and/or from the moveable belt 32 in areas in which such transfer of heating and/or cooling is less desirable. The internal recesses 176 reside interiorly within the cylindrical wall 134 of the rotatable caster wheel 130 and, due to this location, substantially preclude the transfer of heating and/or cooling effects from the temperature-controlled shoes 24 and/or from the moveable belt 32 to certain radially-inboard regions of the cylindrical wall 134 adjacent the positions of the internal recesses 176, thereby more readily concentrating the heating and/or cooling effects at the intended working sections of the mold cavity 144 (e.g., in the case of the grid mold cavity 146, the intended working sections can include one or more or all of the grid wire sections, bottom and top frame sections, side frame sections, and/or lug sections), according to this embodiment. Dissipation of the heating and/or cooling effects at the radially-inboard regions of the cylindrical wall 134 is thereby reduced. At the interior locations, the internal recesses 176 can underly a section or more of the mold cavity 144 and of the grid mold cavity 146; the section subject to underlying can be less than a full axial extent of the mold cavity 144 and of the grid mold cavity 146 or of individual grid mold cavities, and/or less than a full circumferential extent of the mold cavity 144 and of the grid mold cavity 146 or of individual grid mold cavities, according to various embodiments. In the second embodiment, and as perhaps best shown in FIGS. 8 and 10, the internal recesses 176 span in the axial direction over a majority of an axial extent of the cylindrical wall 134, and span in the axial direction over the full axial extent of the mold cavity 144 and of the grid mold cavity 146 or of individual grid mold cavities.

Further, in the radial direction of the cylindrical wall 134 and relative to a radial thickness thereof, the internal recesses 176 can have various positions therealong. In the second embodiment, the internal recesses 176 are positioned more radially-outboard at the radial thickness of the cylindrical wall 134 than radially-inboard, and are positioned adjacent and nearer to the exterior surface 142, mold cavity 144, and grid mold cavity 146. Due to their positions, the internal recesses 176 divide and segment the radial thickness and extent of the cylindrical wall 134 into a radially-exterior portion 178 and a radially-interior portion 180. The radially-exterior portion 178, per this embodiment, is much thinner than the radially-interior portion 180—this relationship has been shown to furnish suitable temperature control and management capabilities at the mold cavity 144, and more readily concentrates the heating and/or cooling effects at the intended working sections of the mold cavity 144 (e.g., in the case of the grid mold cavity 146, the intended working sections can include one or more or all of the grid wire sections, bottom and top frame sections, side frame sections, and/or lug sections), according to this embodiment; still, this relationship need not necessarily be true in other embodiments. Indeed, a first radial thickness of the radially-exterior portion 178 is lesser in value than a second radial thickness of the radially-interior portion 180. In an embodiment, the first radial thickness of the radially-exterior portion 178 can have a value that is approximately five to twenty-five percent (5-25%) that of the radially-interior portion 180; still, other percentage values and ranges are possible. Again here, this relationship has been shown to furnish suitable temperature control and management capabilities at the mold cavity 144, and more readily concentrates the heating and/or cooling effects at the intended working sections of the mold cavity 144 (e.g., in the case of the grid mold cavity, the intended working sections can include one or more or all of the grid wire sections, bottom and top frame sections, side frame sections, and/or lug sections), according to this embodiment; still, this relationship need not necessarily be true in other embodiments. Furthermore, a radial depth and extent of the internal recesses 176, per an example, can have a value of approximately one-eighth of an inch (0.125 inches; 3.175 millimeters); still, other radial depth values are possible in other examples. The internal recesses 176 can be formed via machining or via another formation technique.

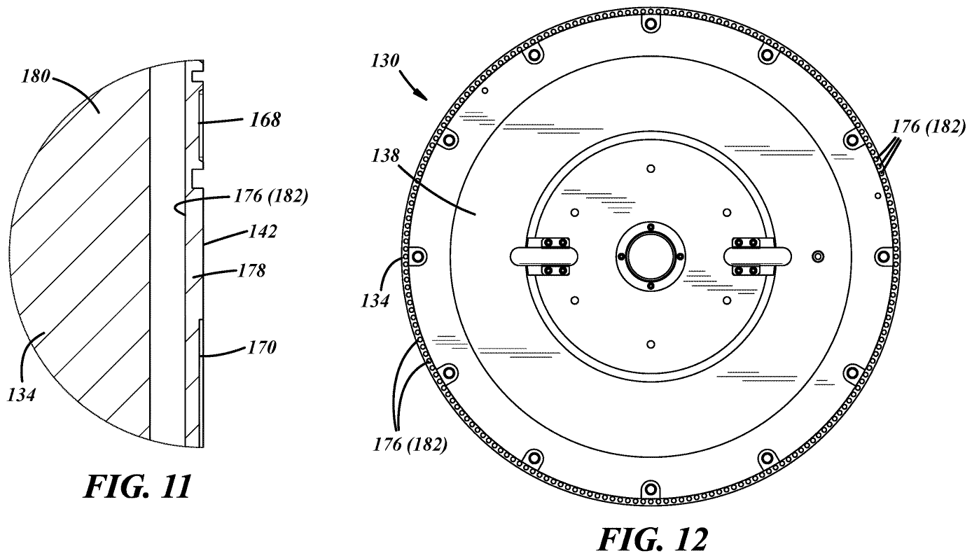

The internal recesses 176 can exhibit various shapes in various embodiments. In the second embodiment, the internal recesses 176 are in the form of a multitude of holes 182. With particular reference to FIG. 12, the holes 182 have cylindrical shapes. The holes 182 are situated along the full circumferential extent of the cylindrical wall 134, mold cavity 144, grid mold cavity 146, and/or individual grid mold cavities. The holes 182 are spaced and distanced apart from one another. Referring now to FIG. 10, each of the holes 182 has an open end 184 and an oppositely-located closed end 186, and each of the holes 182 spans between the open end 184 and closed end 186. In the second embodiment, the open end 184 is located at or adjacent a bottom region BR of the cylindrical wall 134, and the closed end 186 is located at or adjacent a top region TR of the cylindrical wall 134. The open end 184 is open at a bottom surface 188 of the cylindrical wall 134, and the closed end 186 is closed adjacent the gate or runner system of the cylindrical wall 134, per this embodiment.

Still further, in alternative embodiments, the pockets and depressions and land strips need not necessarily be provided with the internal recess in a rotatable caster wheel; for example, the internal recess could be provided in a rotatable caster wheel in the absence of the pockets and depressions and land strips. Or the internal recess could be provided in a rotatable caster wheel with the pockets but without the depressions and land strips, or the internal recess could be provided in a rotatable caster wheel with the depressions and land strips but without the pockets.

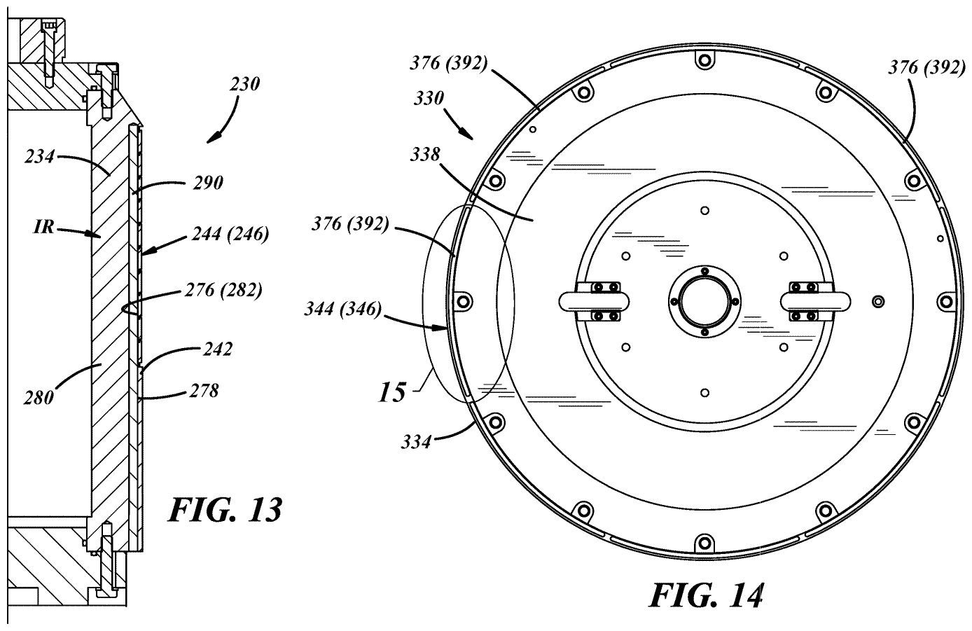

Turning now to FIG. 13, a third embodiment of the rotatable caster wheel is presented. In the third embodiment, certain corresponding components and elements are numbered similarly but with numerals 2xx when referring to this third embodiment. For example, the rotatable caster wheel is referenced by numeral 30 in the first embodiment and is correspondingly referenced by numeral 230 in the third embodiment. Moreover, many similarities exist between the third embodiment and previous embodiments, some of which may not be repeated here in the description of the third embodiment. At least certain appreciable differences between the embodiments are described.

In the third embodiment, the rotatable caster wheel 230 exhibits the temperature control and management capabilities via a multitude of inserts 290. The inserts 290 can have various designs and constructions in various embodiments. The inserts 290 are disposed at an interior region IR of the cylindrical wall 234 and are situated interiorly within the cylindrical wall 134. In general, the inserts 290 are composed of materials that can possess thermal conductivity properties that differ from that of the cylindrical wall 234, enabling enhanced control of the transfer of heating and/or cooling effects from the temperature-controlled shoes 24 and/or from the moveable belt 32. Depending on whether the thermal conductivity properties of the inserts 290 are higher or lower than that of the cylindrical wall 234, the inserts 290 can serve to increase the transfer of heating and/or cooling effects at the working sections of the mold cavity 244 from the temperature-controlled shoes 24 and/or from the moveable belt 32, or decrease the transfer of heating and/or cooling effects at the working sections of the mold cavity 244 from the temperature-controlled shoes 24 and/or from the moveable belt 32. This provides the ability to more readily concentrate the heating and/or cooling effects at the working sections of the mold cavity 244, and/or to more readily dissipate the heating and/or cooling effects from the working sections of the mold cavity 244, according to various embodiments.

In the third embodiment, the inserts 290 can be set in place within the internal recesses 276 and holes 282; still, in other embodiments, the inserts 290 could have other placements. The inserts 290 can be inserted via the open end 284. The inserts 290 can be placed in all of the internal recesses 276 and holes 282, or in less than all and only in some of the internal recesses 276 and holes 282. At the respective internal recess 276 and hole 282, the insert 290 can fully occupy the whole thereof, or the insert 290 can occupy less than the whole thereof such as by filling only one-half of the void established by the respective internal recess 276 and hole 282. At their locations, the inserts 290 can underly a section or more of the mold cavity 244 and of the grid mold cavity 246; the section subject to underlying can be less than a full axial extent of the mold cavity 244 and of the grid mold cavity 246 or of individual grid mold cavities, and/or less than a full circumferential extent of the mold cavity 244 and of the grid mold cavity 246 or of individual grid mold cavities, according to various embodiments. In the third embodiment of FIG. 13, the inserts 290 extend in the axial direction across a majority of the axial extent of the cylindrical wall 234, and extend in the axial direction across the full axial extent of the mold cavity 244 and of the grid mold cavity 246 or of individual grid mold cavities. Further, in the radial direction of the cylindrical wall 234 and relative to the radial thickness thereof, the inserts 290 can have various positions there-along. In the third embodiment, the inserts 290 are positioned more radially-outboard at the radial thickness of the cylindrical wall 234 than radially-inboard, and are positioned adjacent and nearer to the exterior surface 242, mold cavity 244, and grid mold cavity 246. Moreover, as before, the cylindrical wall 234 is segmented into the radially-exterior and radially-interior portions 278, 280, per this third embodiment. The inserts 290 can take various forms. In FIG. 13, the inserts 290 are in the form of a monolithic and one-piece structure; in other embodiments, the inserts 290 can be in the form of multiple structures and/or filler material, as examples.

Yet further, according to the third embodiment, the inserts 290 can be composed of various materials that differ in material composition from that of the cylindrical wall 234. The inserts 290 can be composed of a first material and the cylindrical wall 234 can be composed of a second material; the first and second materials can differ in composition relative to each other. In various examples, the inserts 290 can be composed of a copper material, a polymer material, and/or a glass material, while the cylindrical wall 234 can be composed of a steel alloy material, a cast iron material, and/or an aluminum alloy material; still, other material compositions are possible for the inserts 290 and for the cylindrical wall 234 in other examples. Moreover, the inserts 290 can possess thermal conductivity properties that differ from that of the cylindrical wall 234. The inserts 290 can possess a first thermal conductivity and the cylindrical wall 234 can possess a second thermal conductivity; the first and second thermal conductivities can differ in value relative to each other. In various examples, the first thermal conductivity can be greater in value (i.e., >) than that of the second thermal conductivity, or the first thermal conductivity can be lesser in value (i.e., <) than that of the second thermal conductivity. Having different material compositions and different accompanying thermal conductivities serves to facilitate adaptability and flexibility in the battery components produced via the rotatable caster wheel 230. For example, thinner portions of the battery components can be subjected to heating and/or cooling effects that more readily dissipate via a higher thermal conductivity property of one or more first inserts 290 relative to that of the cylindrical wall 234; and, conversely, thicker portions of the battery components can be subjected to heating and/or cooling effects that are more readily concentrated via a lower and more insulative thermal conductivity property of one or more second inserts 290 relative to that of the cylindrical wall 234. Still further, in the third embodiment, the pockets and depressions and land strips could be provided, as previously described, though need not be provided.

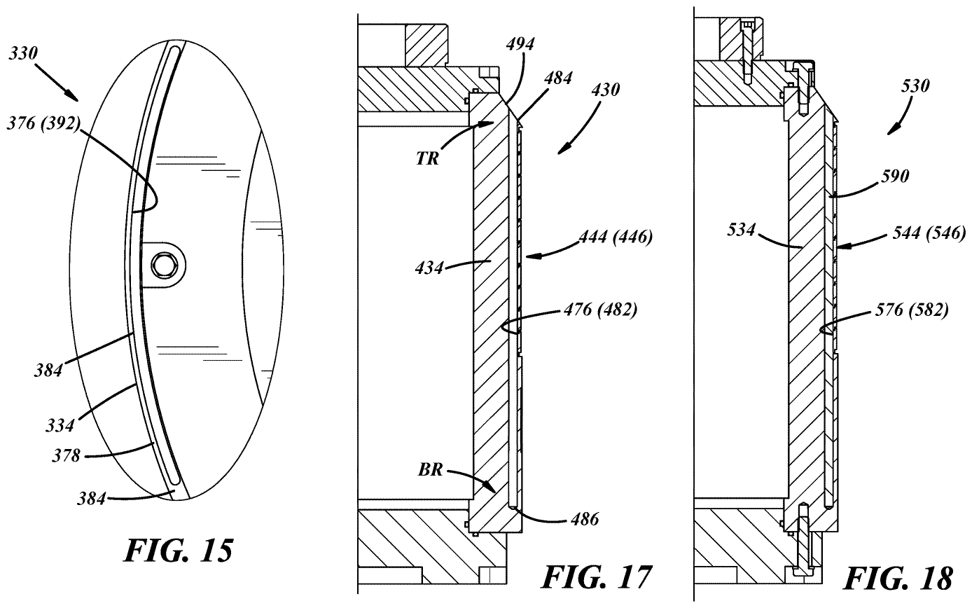

Turning now to FIGS. 14-15, a fourth embodiment of the rotatable caster wheel is presented. In the fourth embodiment, certain corresponding components and elements are numbered similarly but with numerals 3xx when referring to this fourth embodiment. For example, the rotatable caster wheel is referenced by numeral 30 in the first embodiment and is correspondingly referenced by numeral 330 in the fourth embodiment. Moreover, many similarities exist between the fourth embodiment and previous embodiments, some of which may not be repeated here in the description of the fourth embodiment. At least certain appreciable differences between the embodiments are described.

In the fourth embodiment, the internal recesses 376 are in the form of a multitude of slots 392. The slots 392 have elongated arc-like shapes. The slots 392 are situated along the full circumferential extent of the cylindrical wall 334, mold cavity 344, grid mold cavity 346, and/or individual grid mold cavities. The slots 392 are spaced and distanced apart from one another. In this embodiment, individual slots 392 have a circumferential expanse and extent that is greater than, and that span over, the full circumferential extents of individual molds and individual grid mold cavities of the respective mold cavity 344 and grid mold cavity 346. As before, the slots 392 can underly a section or more of the mold cavity 344 and of the grid mold cavity 346; the section subject to underlying can be less than a full axial extent of the mold cavity 344 and of the grid mold cavity 346 or of individual grid mold cavities, according to various embodiments. The slots 392 span in the axial direction over a majority of the axial extent of the cylindrical wall 334, and span in the axial direction over the full axial extent of the mold cavity 344 and of the grid mold cavity 346 or of individual grid mold cavities. Each of the slots 392 has an open end 384 and an oppositely-located closed end (not depicted in FIGS. 14-15). In the fourth embodiment, the open end 384 is located at or adjacent the bottom region of the cylindrical wall 334, and the closed end is located at or adjacent the top region of the cylindrical wall 334. The open end 384 is open at the bottom surface 388 of the cylindrical wall 334, and the closed end is closed adjacent the gate or runner system of the cylindrical wall 334, per this embodiment. Still further, in the fourth embodiment, the pockets and depressions and land strips could be provided, as previously described, though need not be provided.

Furthermore, in an alternative to the fourth embodiment, a multitude of inserts can be set in place within the internal recesses 376 and slots 392. As before, the inserts can fully occupy the whole of the slots 392, or the inserts can occupy less than the whole thereof. The inserts can take various forms, as previously described, and can be in the form of a monolithic and one-piece structure or can be in the form of multiple structures and/or filler material, as examples. The inserts can be composed of various materials that differ in material composition from that of the cylindrical wall 334, and can possess thermal conductivity properties that differ from that of the cylindrical wall 334.

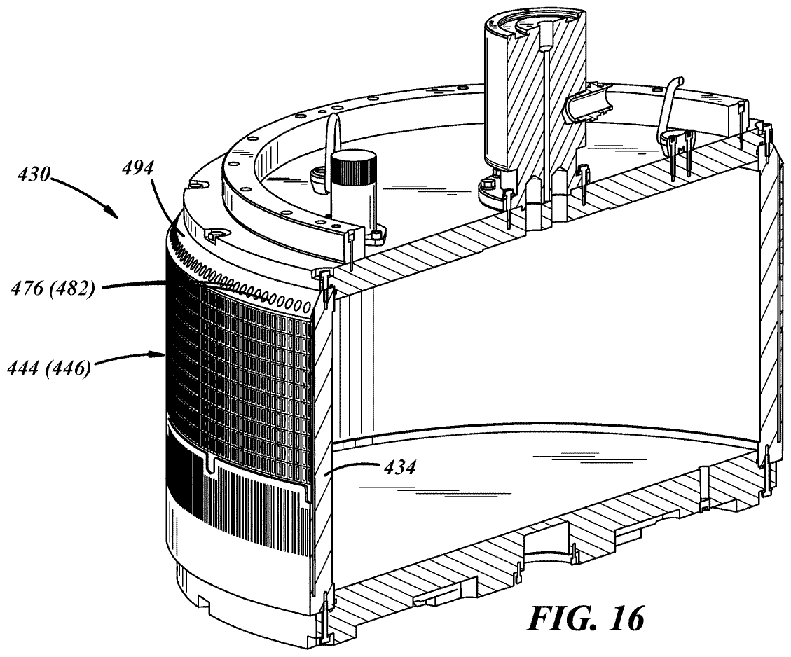

Turning now to FIGS. 16-17, a fifth embodiment of the rotatable caster wheel is presented. In the fifth embodiment, certain corresponding components and elements are numbered similarly but with numerals 4xx when referring to this fifth embodiment. For example, the rotatable caster wheel is referenced by numeral 30 in the first embodiment and is correspondingly referenced by numeral 430 in the fifth embodiment. Moreover, many similarities exist between the fifth embodiment and previous embodiments, some of which may not be repeated here in the description of the fifth embodiment. At least certain appreciable differences between the embodiments are described. In the fifth embodiment, the internal recesses 476 are in the form of the multitude of holes 482. But unlike the previous embodiments with holes, the holes 482 of the fifth embodiment have their open ends 484 located at or adjacent the top region TR of the cylindrical wall 434, and have their closed ends 486 located at or adjacent the bottom region BR of the cylindrical wall 434. The open end 484 is open at a surface 494 of the gate or runner system of the cylindrical wall 434, according to this embodiment. Further, in the fifth embodiment, the pockets and depressions and land strips could be provided, as previously described, though need not be provided.

Turning now to FIG. 18, a sixth embodiment of the rotatable caster wheel is presented. In the sixth embodiment, certain corresponding components and elements are numbered similarly but with numerals 5xx when referring to this sixth embodiment. For example, the rotatable caster wheel is referenced by numeral 30 in the first embodiment and is correspondingly referenced by numeral 530 in the sixth embodiment. Moreover, many similarities exist between the sixth embodiment and previous embodiments, some of which may not be repeated here in the description of the sixth embodiment. At least certain appreciable differences between the embodiments are described. The sixth embodiment is similar to the fifth embodiment, in particular. The multitude of inserts 590 can be set in place within the internal recesses 576 and holes 582. As before, the inserts 590 can fully occupy the whole of the holes 582, or the inserts 590 can occupy less than the whole thereof. The inserts 590 can take various forms, as previously described, and can be in the form of a monolithic and one-piece structure or can be in the form of multiple structures and/or filler material, as examples. The inserts 590 can be composed of various materials that differ in material composition from that of the cylindrical wall 534, and can possess thermal conductivity properties that differ from that of the cylindrical wall 534.

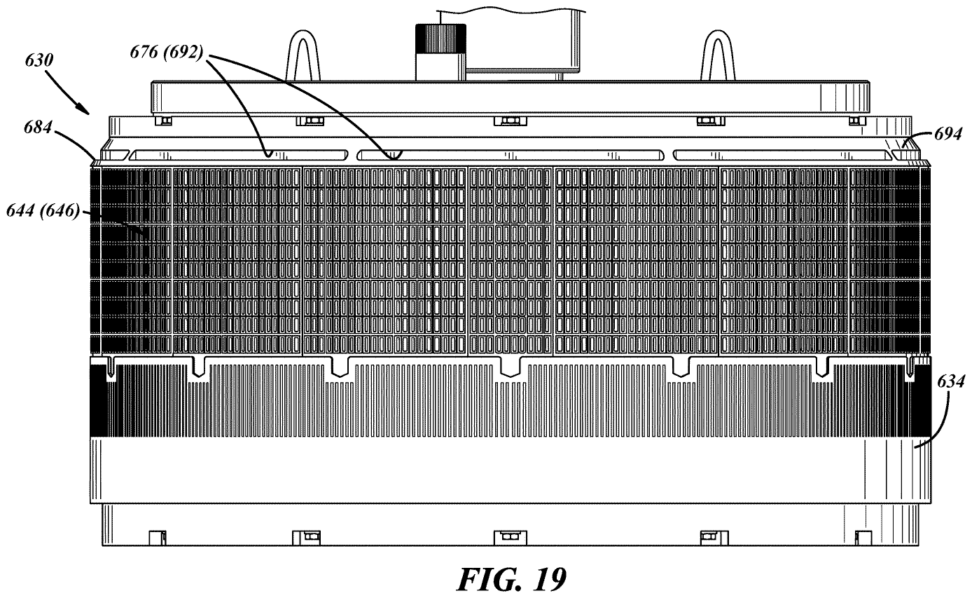

Turning now to FIG. 19, a seventh embodiment of the rotatable caster wheel is presented. In the seventh embodiment, certain corresponding components and elements are numbered similarly but with numerals 6xx when referring to this seventh embodiment. For example, the rotatable caster wheel is referenced by numeral 30 in the first embodiment and is correspondingly referenced by numeral 630 in the seventh embodiment. Moreover, many similarities exist between the seventh embodiment and previous embodiments, some of which may not be repeated here in the description of the seventh embodiment. At least certain appreciable differences between the embodiments are described. In the seventh embodiment, the internal recesses 676 are in the form of the multitude of slots 692. But unlike the previous embodiments with slots, the slots 692 of the seventh embodiment have their open ends 684 located at or adjacent the top region of the cylindrical wall 634, and have their closed ends located at or adjacent the bottom region of the cylindrical wall 634. The open end 684 is open at the surface 694 of the gate or runner system of the cylindrical wall 634, according to this embodiment. In an alternative to the seventh embodiment, a multitude of inserts can be set in place within the internal recesses 676 and slots 692. As before, the inserts can fully occupy the whole of the slots 692, or the inserts can occupy less than the whole thereof. The inserts can take various forms, as previously described, and can be in the form of a monolithic and one-piece structure or can be in the form of multiple structures and/or filler material, as examples. The inserts can be composed of various materials that differ in material composition from that of the cylindrical wall 634, and can possess thermal conductivity properties that differ from that of the cylindrical wall 634. Further, in the seventh embodiment, the pockets and depressions and land strips could be provided, as depicted and previously described, though need not be provided.

In general, while a multitude of embodiments have been depicted and described with a multitude of components in each embodiment, in alternative embodiments of the belt caster wheel assembly the components of various embodiments could be intermixed, combined, and/or exchanged for one another. In other words, components described in connection with a particular embodiment are not necessarily exclusive to that particular embodiment.

As used herein, the terms “general,” “generally,” “approximately,” and “substantially” are intended to account for the inherent degree of variance and imprecision that is often attributed to, and often accompanies, any design and manufacturing process and measurement, including engineering tolerances, and without deviation from the relevant functionality and intended outcome, such that mathematical precision and exactitude is not implied and, in some instances, is not strictly possible. In other instances, the terms “general,” “generally,” “approximately,” and “substantially” are intended to represent the inherent degree of uncertainty that is often attributed to any quantitative comparison, value, and measurement calculation, or other representation, such that mathematical precision and exactitude is not implied and, in some instances, is not strictly possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

1. A belt caster wheel assembly for a battery component continuous casting machine, the belt caster wheel assembly comprising:
a rotatable caster wheel having a cylindrical wall with a mold cavity residing at an exterior surface of said cylindrical wall, said mold cavity having a plurality of first grooves, a plurality of second grooves, and a plurality of lands, said plurality of first grooves and said plurality of second grooves intersecting one another, said plurality of lands established among said plurality of first and second grooves and the intersections thereamong, said mold cavity further having a plurality of pockets residing in at least some of said plurality of lands;
a moveable belt in confrontation with a circumferential working region of said mold cavity, said circumferential working region comprising at least some of said plurality of first grooves, said plurality of second grooves, said plurality of lands, and said plurality of pockets; and
at least one temperature-controlled shoe engaging said moveable belt at least adjacent the confrontation with said circumferential working region of said mold cavity.

2. The belt caster wheel assembly as set forth in claim 1, wherein a first radial depth of said plurality of pockets is less than a second radial depth of said plurality of first grooves or of said plurality of second grooves or of both said plurality of first and second grooves.

3. The belt caster wheel assembly as set forth in claim 1, wherein said plurality of pockets have a first area of expanse at said exterior surface and said at least some plurality of lands have a second area of expanse at said exterior surface, said first area of expanse being greater in value than said second area of expanse.

4. The belt caster wheel assembly as set forth in claim 1, further comprising a plurality of protrusions and a plurality of land strips residing at said exterior surface of said cylindrical wall and located adjacent said mold cavity, said moveable belt or said at least one temperature-controlled shoe or both of said moveable belt and at least one temperature-controlled shoe engaging said plurality of land strips amid use of the belt caster wheel assembly.

5. The belt caster wheel assembly as set forth in claim 1, wherein said mold cavity is a grid mold cavity, and said plurality of first grooves is a plurality of first grid wire grooves and said plurality of second grooves is a plurality of second grid wire grooves.

6. The belt caster wheel assembly as set forth in claim 1, wherein at least one internal recess resides within said cylindrical wall, said at least one internal recess underlying at least a section of said mold cavity.

7. The belt caster wheel assembly as set forth in claim 6, wherein said at least one internal recess spans over a majority of an axial extent of said cylindrical wall.

8. The belt caster wheel assembly as set forth in claim 6, wherein said at least one internal recess underlies a full axial extent of said mold cavity.

9. The belt caster wheel assembly as set forth in claim 6, wherein said at least one internal recess segments said cylindrical wall into a radially-exterior portion and a radially-interior portion, said mold cavity located at said radially-exterior portion, said radially-exterior portion having a first radial thickness that is lesser in value than a second radial thickness of said radially-interior portion.

10. The belt caster wheel assembly as set forth in claim 6, wherein said at least one internal recess is a plurality of holes residing within said cylindrical wall and situated along a circumferential extent of said cylindrical wall.

11. The belt caster wheel assembly as set forth in claim 6, wherein said at least one internal recess is a plurality of slots residing within said cylindrical wall, individual slots of said plurality of slots span over full circumferential extents of individual molds of said mold cavity.

12. The belt caster wheel assembly as set forth in claim 6, wherein said at least one internal recess has an open end adjacent a bottom region of said cylindrical wall or adjacent a top region of said cylindrical wall.

13. The belt caster wheel assembly as set forth in claim 6, wherein said at least one internal recess has a closed end adjacent a bottom region of said cylindrical wall or adjacent a top region of said cylindrical wall.

14. The belt caster wheel assembly as set forth in claim 1, further comprising at least one insert disposed at an interior region of said cylindrical wall, said at least one insert spanning over at least a section of said mold cavity.

15. The belt caster wheel assembly as set forth in claim 14, wherein said at least one insert possesses a first thermal conductivity and said cylindrical wall possesses a second thermal conductivity, said first thermal conductivity and said second thermal conductivity having values that differ relative to each other.

16. The belt caster wheel assembly as set forth in claim 14, wherein said at least one insert possesses a first thermal conductivity and said cylindrical wall possesses a second thermal conductivity, said first thermal conductivity being greater than said second thermal conductivity.

17. The belt caster wheel assembly as set forth in claim 14, wherein said at least one insert possesses a first thermal conductivity and said cylindrical wall possesses a second thermal conductivity, said first thermal conductivity being less than said second thermal conductivity.

18. A battery component continuous casting machine comprising said belt caster wheel assembly as set forth in claim 1.

19. A belt caster wheel assembly for a battery component continuous casting machine, the belt caster wheel assembly comprising:
a rotatable caster wheel having a cylindrical wall with a mold cavity residing at an exterior surface of said cylindrical wall, said cylindrical wall having at least one internal recess residing therein, said at least one internal recess underlying at least a section of said mold cavity;
a moveable belt in confrontation with a circumferential working region of said mold cavity; and
at least one temperature-controlled shoe engaging said moveable belt at least adjacent the confrontation with said circumferential working region of said mold cavity.

20. The belt caster wheel assembly as set forth in claim 19, wherein said mold cavity has a plurality of first grooves, a plurality of second grooves, and a plurality of lands, said plurality of first grooves and said plurality of second grooves intersecting one another, said plurality of lands established among said plurality of first and second grooves and the intersections thereamong, said mold cavity further having a plurality of pockets residing in at least some of said plurality of lands.

21. The belt caster wheel assembly as set forth in claim 19, further comprising at least one insert located within said at least one internal recess, said at least one insert composed of a first material and said cylindrical wall composed of a second material that differs from said first material.

22. The belt caster wheel assembly as set forth in claim 21, wherein said at least one insert possesses a first thermal conductivity and said cylindrical wall possesses a second thermal conductivity, said first thermal conductivity and said second thermal conductivity having values that differ relative to each other.

23. The belt caster wheel assembly as set forth in claim 19, wherein said at least one internal recess segments said cylindrical wall into a radially-exterior portion and a radially-interior portion, said mold cavity located at said radially-exterior portion, said radially-exterior portion having a first radial thickness that is lesser in value than a second radial thickness of said radially-interior portion.

24. The belt caster wheel assembly as set forth in claim 19:
wherein said at least one internal recess is a plurality of holes residing within said cylindrical wall and situated along a circumferential extent of said cylindrical wall; or
wherein said at least one internal recess is a plurality of slots residing within said cylindrical wall, individual slots of said plurality of slots span over full circumferential extents of individual molds of said mold cavity.

25. A belt caster wheel assembly for a battery component continuous casting machine, the belt caster wheel assembly comprising:
a rotatable caster wheel having a cylindrical wall with a mold cavity residing at an exterior surface of said cylindrical wall, said mold cavity having a plurality of first grooves, a plurality of second grooves, and a plurality of lands, said plurality of lands established among said plurality of first and second grooves, said mold cavity further having a plurality of pockets residing in at least some of said plurality of lands, said cylindrical wall having at least one internal recess residing therein, said at least one internal recess underlying at least a section of said mold cavity;
at least one insert disposed within said at least one internal recess;
a moveable belt in confrontation with a circumferential working region of said mold cavity, said circumferential working region comprising at least some of said plurality of first grooves, said plurality of second grooves, said plurality of lands, and said plurality of pockets; and
at least one temperature-controlled shoe engaging said moveable belt at least adjacent the confrontation with said circumferential working region of said mold cavity.
